(19) United States
(12) Patent Application Publication
(10) Pub. No.: US 2012/0029938 A1
(43) Pub. Date: Feb. 2, 2012

(54) Anonymous Healthcare and Records System

(75) Inventors: Kristin Estella Lauter, Redmond, WA (US); Melissa E. Chase, Redmond, WA (US)

(73) Assignee: MICROSOFT CORPORATION, Redmond, WA (US)

(21) Appl. No.: 12/844,532

(22) Filed: Jul. 27, 2010

(51) Int. Cl. G06Q 50/00; G06Q 40/00; G06Q 10/00

(52) U.S. Cl. 705/3; 705/2; 726/26

(57) ABSTRACT

Described herein is using cryptographic techniques (anonymous proof systems) to ensure the anonymity of health records when processing payment claims related to insurers and pharmacies. A patient receives a patient token from an insurer, which the patient delegates to a healthcare provider. The delegated token is processed into an anonymized token that identifies the healthcare provider and the medical service provided, without including information by which the patient is directly identifiable. The anonymized token includes data by which the insurer validates the token. For prescriptions, an anonymized token may be generated as an endorsement for the patient (e.g., a printed barcode) and an unendorsed token transmitted to the pharmacy. The pharmacy combines data of the endorsement and the unendorsed token into an anonymous combined token that is transmitted to the insurer for payment.

### BACKGROUND

Patient privacy is a significant concern when dealing with medical matters. As medical records are converted to electronic form, the risk of compromising patients' privacy increases significantly, because the electronic format makes it easier to misuse patients' data.

At the same time, such data is accessible to many parties who do not need much, if any, of it. For example, insurers and pharmacies are not actively involved in patient care. However, patients who are insured are required to share the entire record of their medical treatment with their insurer in order to receive benefits, and those patients can only hope that the insurance company and its employees maintain the records confidentially. Similarly, a pharmacy may store data regarding patient prescriptions, such as all prescriptions filled for each patient.

In actuality, there is no medical reason for these parties to have this information. For example, an insurer only needs enough information to be able to prevent fraud and verify that the provided treatment is covered under the patient's policy. A pharmacy only needs to know that the patient has a valid prescription for the medication being dispensed.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards using cryptographic techniques (anonymous proof systems) to ensure the anonymity of health records when processing payment claims to insurers and pharmacies. In one aspect, a mechanism (e.g., at a healthcare provider) inputs a delegated patient token comprising attributes of a patient, and data of an insurer by which the insurer is able to validate another token corresponding to the patient token. The delegated token is processed into an anonymized token that identifies the healthcare provider (or pharmacy) and identifies one or more covered medical services or products for which reimbursement from the insurer is desired. The anonymized token does not include information by which the patient is directly identifiable, and may be transmitted to the insurer for payment.

In one aspect, an encrypted patient record corresponding to a medical procedure performed with respect to the patient is maintained, e.g., at a health system/service. In another aspect, anonymous data corresponding to the medical procedure performed with respect to the patient is transmitted to a data aggregator, such as for use in medical research.

For prescriptions, an anonymized token may be generated in two parts, comprising an endorsement associated with the patient (e.g., given to the patient by the healthcare provider as a printed barcode), and an unendorsed token transmitted to the pharmacy from the healthcare provider. The pharmacy combines data corresponding to the unendorsed token with data corresponding to the endorsement into an anonymous combined token, and transmits the anonymous combined token to an appropriate recipient (e.g., the insurer) for payment.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram showing parties and other aspects of a healthcare environment including an anonymous healthcare and records system.

FIG. 2 is a flow diagram showing example steps that may be taken to provide an anonymous healthcare and records environment.

FIG. 3 is a block diagram showing how tokens are used to facilitate an anonymous healthcare and records system/environment including for providing medical services.

FIG. 4 is a block diagram showing how tokens are used to facilitate an anonymous healthcare and records system/environment including for providing prescribed products.

FIG. 5 shows an illustrative example of a computing environment into which various aspects of the present invention may be incorporated.

### DETAILED DESCRIPTION

Various aspects of the technology described herein are generally directed towards a technology by which payment for services and/or pharmaceutical products can be achieved without the patient identity being revealed to the insurer or pharmacy. In one implementation, this may be accomplished without separate visits by the same patient being linkable to one another. Further, anonymized versions of patients' records may be uploaded to a data aggregator service, such as for purposes of medical research.

To this end, the various parties (healthcare provider, insurer, patient and pharmacy) may have identities in a public key infrastructure. As described herein, a patient sets up an insurance policy with the insurer and performs an interactive protocol with the insurer which results in the patient possessing a electronically signed proof statement (a token) indicating that the patient possesses a valid insurance policy with certain properties. This token is presented to a healthcare provider (e.g., doctor or hospital) and is used to generate anonymized, unlinkable signed authorization statements, which are presented to the insurer for payment. In a similar manner, a pharmacy receives payment from the insurer for a prescription without learning the patient's identity.

While the examples herein are directed towards typical medical scenarios, it should be understood that any of the examples herein are non-limiting, and other scenarios may benefit from the technology described herein. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used in various ways that provide benefits and advantages in computing and privacy in general.

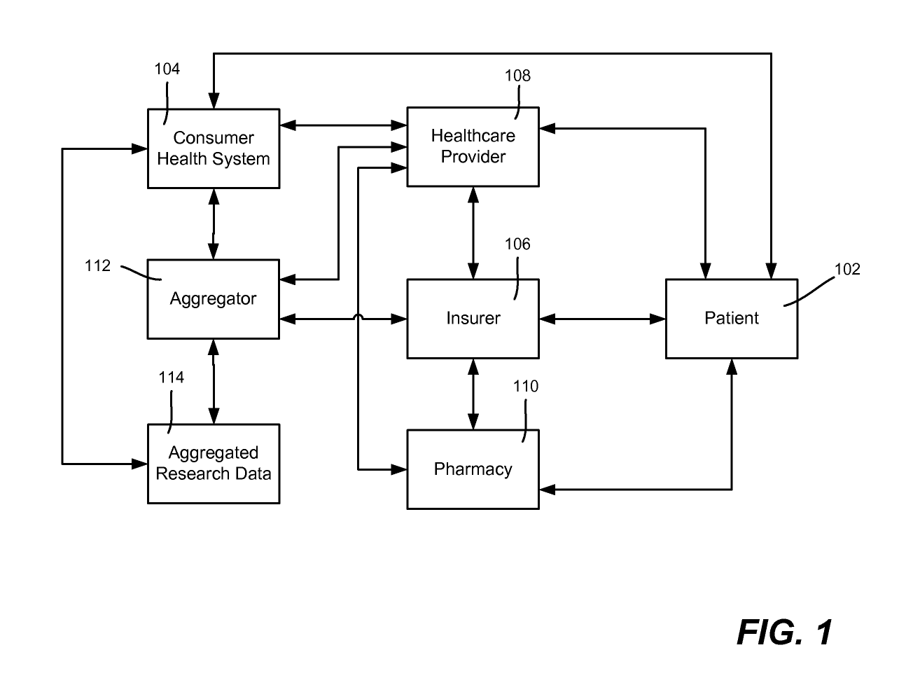

FIG. 1 shows a block diagram representing various parties in a healthcare environment, including a patient 102 having access to the healthcare environment, such as via a consumer health system 104, e.g., Microsoft Amalga™. At some appropriate time, the patient 102 (or the patient's employer or the like) sets up an insurance policy with an insurer 106. Using an anonymous credential (proof) system, the patient 102 receives one or more tokens from the insurer 106. These may be in the form of data on smart cards, electronic certificates that can be accessed as needed (e.g., via the internet) and so forth. As used herein, “token” refers to any appropriate set of data, in any suitable data structure, based upon anonymous credential system technology. Such anonymous credential systems are known such as described in U.S. Pat. Nos. 5,521,980 and 5,604,805, herein incorporated by reference; other references include M. Belenkiy, J. Camenisch, M. Chase, M. Kohlweiss, A. Lysyanskaya and Hovav Shacham, “P-signatures and Noninteractive Anonymous Credentials,” Crypto 2008, and M. Belenkiy, J. Camenisch, M. Chase, M. Kohlweiss, A. Lysyanskaya, and H. Shacham, “Randomizable proofs and delegatable anonymous credentials,” Crypto 2009. Idemix is another suitable anonymous credential system technology, as is the technology described by J. Camenisch and A. Lysyanskaya, “A signature scheme with efficient protocols,” SCN '02, and D. Chaum, “Security without identification: Transaction systems to make big brother obsolete,” Communications of the ACM, 28(10):1030-1044, October 1985.

As described herein and in general, the tokens are later used in conjunction with the healthcare provider 108 to produce anonymized tokens, which are presented back to the insurer 106 for payment for services. Note that the insurance company may need to revoke tokens, for example, if a patient/organization cancels the policy or otherwise stops paying the premium. Revocation may be done using existing anonymous credential revocation techniques, such as described in J. Camenisch and A. Lysyanskaya. “Dynamic accumulators and application to efficient revocation of anonymous credentials. Crypto '02.

In the anonymized token, the health record is not associated with this patient when shared with the insurer 106 or a pharmacy 110. Instead, when the patient 102 visits the healthcare provider 108, a private record of treatment is generated and stored in the patient's confidential health record. In one example scenario, when the patient 102 is treated by the healthcare provider 108, the healthcare provider 108 generates a record of this visit and uploads it in a secure manner to the patient's confidential personal clinical health record, such as maintained at the consumer health system 104. The patient's private record is maintained encrypted and is not viewable by the consumer health system 104 or anyone else, without explicit authorization and the appropriate secret keys.

As described below, the healthcare provider 108 submits a claim to the insurer 106 and payment is processed without the insurer 106 learning for which patient the payment is being made.

In another typical scenario, if the healthcare provider 108 prescribes medication for the patient, the healthcare provider 108 transmits a token (or partial token as described below) containing relevant information to the pharmacy 110. This token does not include information by which the patient is identifiable, but does comprise a signed authorization statement (possibly including state-provided data) indicating that the provider (doctor) is authorized by the state to prescribe medication for the patient. The transmission may be by email, uploading the token to a certain site, and so forth.

As also described below, the healthcare provider 108 additionally generates a digitally signed prescription token (e.g., in the form of a printed barcode) for the patient to take to the pharmacy 110 to pick up the prescription. Note that a physical printout is not necessarily provided, as for example, a barcode may be downloaded to the patient's cell phone or other such device where it can be scanned at the pharmacy.

FIG. 1 further shows a mechanism by which an anonymized version of the patient's record may be (optionally) generated and uploaded to an aggregator 112, such as for aggregation into research data 114. Various ways to anonymize such data are known; however, if the anonymity needs to be revoked at a future time, solutions such as involving the use of a trusted third party may be employed.

In this way, the healthcare provider 108 may act as the trusted representative of the patient 102 in the transactions with insurer 106 and pharmacy 110. More particularly, the healthcare provider 108 interacts with the pharmacy 110 to and bills the insurer 106 on behalf of the patient 102 using tokens in an anonymized, delegatable, and unlinkable credentialing system. As described below, safeguards may be used ensure that such tokens are not abused (e.g., passed on to others for multiple use).

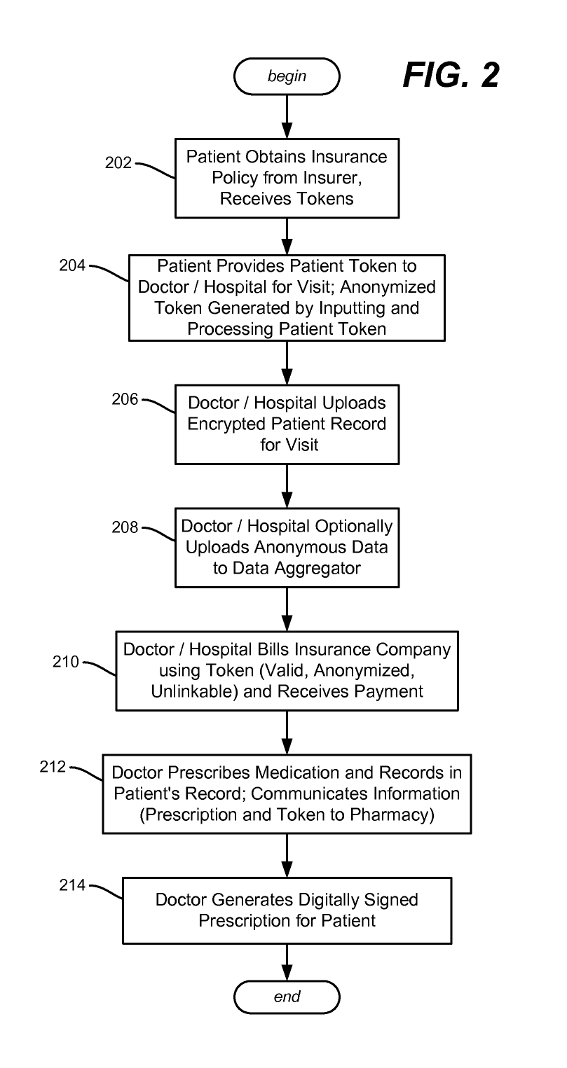

FIG. 2 summarizes various aspects of the anonymous healthcare and records technology based upon cryptographic tools including anonymous credentials, beginning at step 202 where the patient obtains the insurance policy from the insurer, and receives the tokens using an anonymous proof system. In general, the token proves that the patient's treatment is covered according to the given policy.

Step 204 represents the patient visiting the doctor/hospital, which accepts tokens representing a valid insurance policy. The patient reveals the relevant part of the policy, and gives the healthcare provider a token for this visit, which is processed into an anonymized token. As described below, some interaction between the doctor and patient may be required to generate the anonymized token that is presented to the insurer for that visit. In one implementation, the doctor/hospital is assumed to be fully trusted by the patient with regard to any record or data generated by that visit.

Step 206 represents the doctor/hospital encrypting the patient's record for that visit and uploading the record to the consumer health system. The doctor/hospital optionally also may upload an anonymized version of patient's visit/health record to the data aggregator system (step 208).

At step 210, doctor/hospital bills the insurer using a valid, anonymized, unlinkable token. The doctor may check (possibly before treatment) that the insurance claim is valid under the patient's policy, and sends the anonymized token to the insurance company, which includes a description of the services provided. The insurance company checks this token and reimburses the claim; that is, the doctor/hospital receives payment after the insurer checks the validity of the token. Note that before performing any procedure on the patient, the doctor/hospital may have a mechanism to check that the token is valid for the desired procedure, at least in part (with the patient responsible for any difference).

Steps 212 and 214 represent various doctor/patient/pharmacy operations. In general, at step 212, the doctor prescribes one or more medications for the patient. This information is included in the patient's record for that visit. Note that once the information is stored electronically, drug-interaction errors may be caught automatically, whereby pharmacies do not need to play as large a role in this process. To communicate the prescription to the pharmacy, the doctor/hospital uses credentials issued by the state that prove the right to prescribe, and generates a signed prescription which is tied to the particular patient via an anonymous token showing that the insurance will cover the medication. The information given to the pharmacy thus includes the prescription details and one or more tokens that the pharmacy can use to present to the insurer for payment/verification of insurance coverage.

As represented by step 214, instead of writing a hand-signed prescription, the doctor may print or otherwise generate a token (e.g., a partial token) comprising a digitally signed prescription to give to the patient to take to the pharmacy (which may be in the form of a barcode). The patient then goes the corresponding pharmacy, which verifies the tokens received from the patient and the doctor before dispensing the appropriate medication. For reimbursement, as proof of the claim that the medical product was indeed received by the patient, the pharmacy combines the token from the doctor and the token from the patient and presents the result to the insurance company, which verifies the proof and reimburses the claim.

In this manner, payment for services and medical products may be achieved without the patient identity being revealed to the insurer or pharmacist, and without separate visits by the same patient being linkable. This is because the anonymous credential system allows users to obtain credentials from an organization, and then access a resource/service while generating tokens proving that they hold the necessary credentials. These tokens are anonymous in that they do not reveal any information about the patient, they cannot be linked back to the initial issuance, and it is not possible to tell whether two tokens were generated using the same credential.

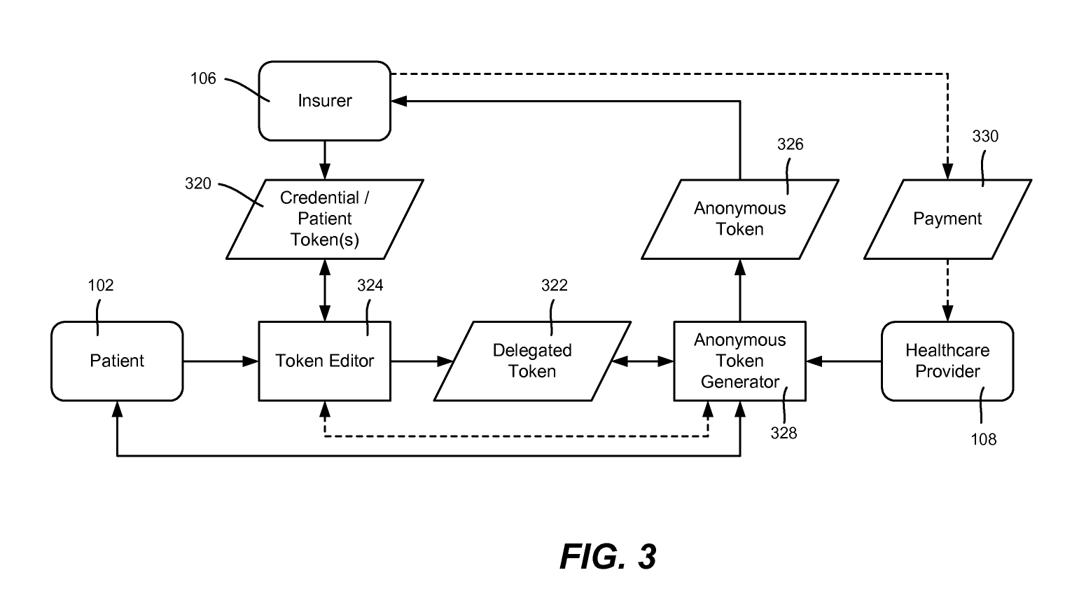

Turning to various aspects of tokens in one implementation, as represented in FIG. 3, a patient 102 receives a credential 320 from an insurer 106 that contains a set of one or more attributes, from which a set of one or more tokens may be issued. The set of tokens correspond to one or more statements that prove that the patient 102 has a given attribute, does not have a given attribute, has (or does not have) an attribute within a given range, or any combination of such statements.

A patient with a credential/token 320 can issue a delegated token 322 to another party, that is, to the healthcare provider 108. The patient 102 can also choose which of its attributes are included in the delegated token 322, e.g., via a token editor 324 (e.g., a software program) that allows certain attributes to be modified. With the delegated token 322, the healthcare provider 108 is able to prove ownership of a credential that was issued by someone with a valid credential from the organization (without revealing information on this intermediary user).

Thus, in one implementation, the token 320 for a patient 102 may comprise a simple credential including the attributes of the policy, assuming that policies have a standardized form. The token for the healthcare provider 108 may comprise the delegated token 322, such as with the visit date hardcoded. Via the token editor 324, the patient may choose to remove some field if it is unrelated to the treatment being performed. For example, dental credentials may be removed on a visit to the patient's primary care doctor. Alternatively, the patient may be more involved in the process, such as to need to authorize every treatment being claimed.

With respect to the anonymous token 326 for the insurer 106, the healthcare provider 108 uses the delegated token 322 to generate a proof (via an anonymous token generator 328, e.g., a software program) that the procedure and/or services claimed are indeed covered. Note that the patient 102 may work with the healthcare provider 108 in the generation of the anonymous token 326. Payment 330 is then sent to the healthcare provider 108 as described above.

In some cases it is important to ensure that no credential is used more than once in the same setting. In this case the patient 102 provides a single-use token for each setting. If the patient 102 generates two or more tokens for the same setting, these may be easily detected, however as long as each use is in a different setting, there is no way to tell that multiple tokens were generated by the same patient 102. Thus, the anonymous token 326 may be combined with a single use label for that patient and that date, which prevents multiple claims for the same procedure.

If the insurers policies are more complex, other features (achievable with existing techniques) may be provided via data in the token. For example, there may be time gaps needed between certain procedures, such as only one rehabilitation procedure per week, which may be included as data in the token. Other features of an insurance company's token may be directed towards proving that a preceding procedure has already been reimbursed, proving that the patient's lifetime or annual cap has not been exceeded, proof of signed results from labs for this patient, and so forth.

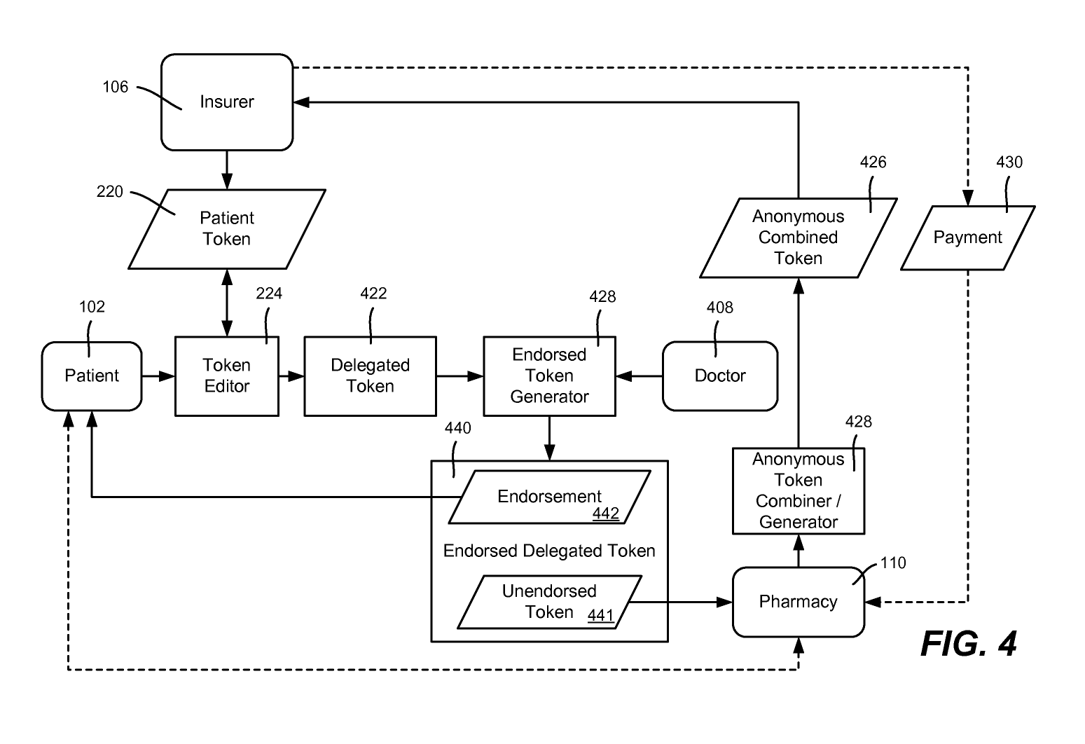

FIG. 4 shows various aspects of the patient/doctor/pharmacy/insurer interactions. Note that a token may be generated in two parts, such that neither is valid without the other. These parts of a token may be referred to herein as an unendorsed token and an endorsement. The endorsement has the feature that it can be made fairly short, regardless of the length of the statement being proven.

For the pharmacy 110, when the doctor 408 is given a delegated token 422, in one implementation the doctor 408 generates (via an endorsed delegated token generator 428, such as a software program) an endorsed delegated token 440 with whatever information is needed to verify the claim. This is basically an endorsed version of the anonymized token for the insurer 108, which reveals only that the prescribing doctor is certified. The unendorsed token (portion) 441 is transmitted or otherwise sent to the pharmacy, with the endorsement 442 printed or otherwise electronically generated in some way (e.g., as a one or two dimensional barcode) and associated with (e.g., given to) the patient 102. As described above, the patient 102 or patient's representative provides the pharmacy 110 with the endorsement 442, which then recombines and anonymizes (e.g., via an anonymous token combiner/generator software program 428) the endorsement 442 with the unendorsed token 441 into an anonymous combined token 426, which is provided to the insurer 106 for payment 430.

Turning to another aspect, there may be situations where revocation of anonymity/allowing auditing is needed. There is thus provided a way to retrieve the treatment information and identity for each patient, such as in case of an audit. One option is to have one (or several) trusted parties who hold a decryption key or shares of a decryption key. When a token is formed to be sent to the insurance company, the doctor can also include data encrypted under this key, comprising treatment information (as well as his or her signature on this information). If an audit is needed, the insurer can ask the trusted parties to perform the decryption. If fraud is discovered, the doctor can then be held responsible.

With respect to preventing the sharing of tokens, an insurer will not want a patient to share a policy with others (other than co-insured family members, for example). One solution is to assume that the parties (including the patients) have verifiable identities in a public key infrastructure. Another, weaker, solution is to require that a patient share all of his or her rights in order to allow someone else to use his policy. Yet another solution is to include the patient name in the policy token that is issued, and in the delegated token the patient shows to the doctor (but not in the anonymized tokens); then the doctor is responsible for verifying the patient's identity.

### Exemplary Operating Environment

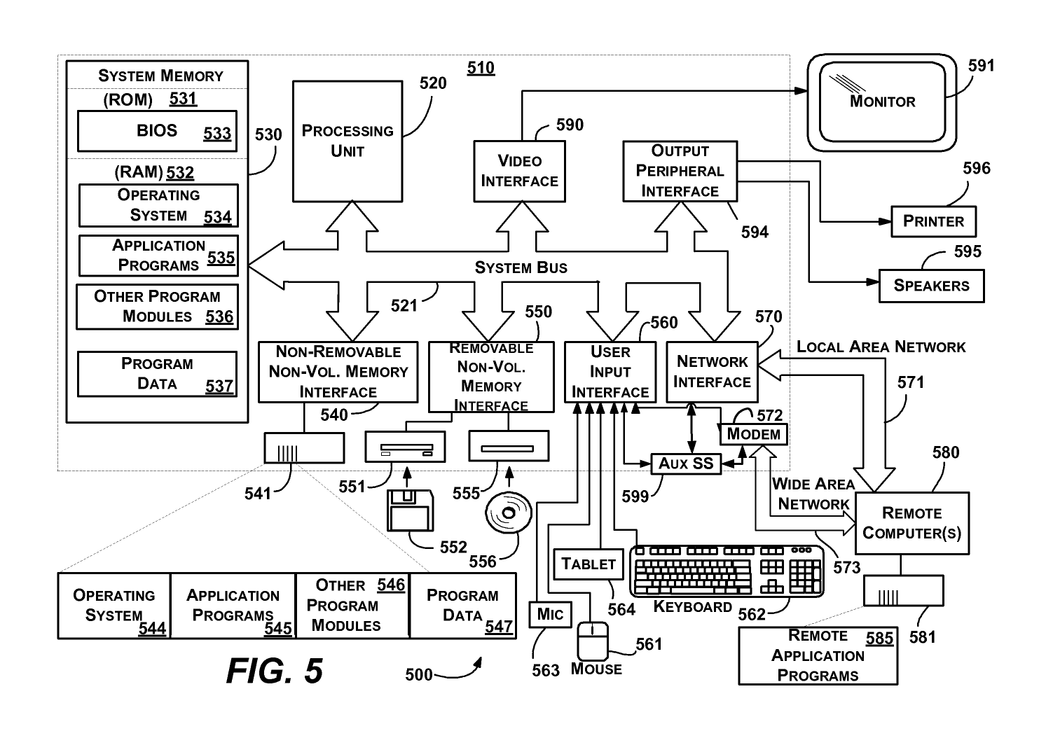

FIG. 5 illustrates an example of a suitable computing and networking environment 500 on which the examples of FIGS. 1-4 may be implemented. The computing system environment 500 is only one example of a suitable computing environment and is not intended to suggest any limitation as to the scope of use or functionality of the invention. Neither should the computing environment 500 be interpreted as having any dependency or requirement relating to any one or combination of components illustrated in the exemplary operating environment 500.

The invention is operational with numerous other general purpose or special purpose computing system environments or configurations. Examples of well-known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 5, an exemplary system for implementing various aspects of the invention may include a general purpose computing device in the form of a computer 510. Components of the computer 510 may include, but are not limited to, a processing unit 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 510 typically includes a variety of computer-readable media. Computer-readable media can be any available media that can be accessed by the computer 510 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 510. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 536 and program data 537.

The computer 510 may also include other removable/non-removable, volatile/nonvolatile computer storage media. By way of example only, FIG. 5 illustrates a hard disk drive 541 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540, and magnetic disk drive 551 and optical disk drive 555 are typically connected to the system bus 521 by a removable memory interface, such as interface 550.

The drives and their associated computer storage media, described above and illustrated in FIG. 5, provide storage of computer-readable instructions, data structures, program modules and other data for the computer 510. In FIG. 5, for example, hard disk drive 541 is illustrated as storing operating system 544, application programs 545, other program modules 546 and program data 547. Note that these components can either be the same as or different from operating system 534, application programs 535, other program modules 536, and program data 537. Operating system 544, application programs 545, other program modules 546, and program data 547 are given different numbers herein to illustrate that, at a minimum, they are different copies. A user may enter commands and information into the computer 510 through input devices such as a tablet, or electronic digitizer, 564, a microphone 563, a keyboard 562 and pointing device 561, commonly referred to as mouse, trackball or touch pad. Other input devices not shown in FIG. 5 may include a joystick, game pad, satellite dish, scanner, or the like. These and other input devices are often connected to the processing unit 520 through a user input interface 560 that is coupled to the system bus, but may be connected by other interface and bus structures, such as a parallel port, game port or a universal serial bus (USB). A monitor 591 or other type of display device is also connected to the system bus 521 via an interface, such as a video interface 590. The monitor 591 may also be integrated with a touch-screen panel or the like. Note that the monitor and/or touch screen panel can be physically coupled to a housing in which the computing device 510 is incorporated, such as in a tablet-type personal computer. In addition, computers such as the computing device 510 may also include other peripheral output devices such as speakers 595 and printer 596, which may be connected through an output peripheral interface 594 or the like.

The computer 510 may operate in a networked environment using logical connections to one or more remote computers, such as a remote computer 580. The remote computer 580 may be a personal computer, a server, a router, a network PC, a peer device or other common network node, and typically includes many or all of the elements described above relative to the computer 510, although only a memory storage device 581 has been illustrated in FIG. 5. The logical connections depicted in FIG. 5 include one or more local area networks (LAN) 571 and one or more wide area networks (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communications over the WAN 573, such as the Internet. The modem 572, which may be internal or external, may be connected to the system bus 521 via the user input interface 560 or other appropriate mechanism. A wireless networking component such as comprising an interface and antenna may be coupled through a suitable device such as an access point or peer computer to a WAN or LAN. In a networked environment, program modules depicted relative to the computer 510, or portions thereof, may be stored in the remote memory storage device. By way of example, and not limitation, FIG. 5 illustrates remote application programs 585 as residing on memory device 581. It may be appreciated that the network connections shown are exemplary and other means of establishing a communications link between the computers may be used.

An auxiliary subsystem 599 (e.g., for auxiliary display of content) may be connected via the user interface 560 to allow data such as program content, system status and event notifications to be provided to the user, even if the main portions of the computer system are in a low power state. The auxiliary subsystem 599 may be connected to the modem 572 and/or network interface 570 to allow communication between these systems while the main processing unit 520 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method performed at least in part on at least one processor comprising:
inputting a delegated patient token comprising attributes of a patient, and
processing the patient token into an anonymized token that identifies a healthcare provider or pharmacy and identifies one or more covered medical services or products for which reimbursement from an insurer is desired without including information by which the patient is directly identifiable.

2. The method of claim 1 further comprising, transmitting the anonymized token to a recipient for payment.

3. The method of claim 1 wherein processing the patient token into the anonymized token comprises including information corresponding to at least one medical procedure performed with respect to the patient.

4. The method of claim 3 further comprising, maintaining an encrypted patient record corresponding to at least one medical procedure performed with respect to the patient.

5. The method of claim 3 further comprising, transmitting anonymous data corresponding to at least one medical procedure performed with respect to the patient to a data aggregator.

6. The method of claim 1 wherein processing the patient token into the anonymized token comprises including information corresponding to at least one prescription provided to the patient.

7. The method of claim 6 wherein processing the patient's anonymized token comprises combining data from an endorsement associated with the patient with an unendorsed token received from a healthcare provider.

8. A system comprising, a mechanism that generates a delegated token from a patient token provided by an insurer to a patient, the patient token comprising attributes of the patient and data of the insurer, and a mechanism that generates an anonymized token from the delegated token, the anonymized token containing data that indicates that the insurer issued the patient token corresponding to the anonymized token, and data that indicates that the patient has received a medical service or product without including information by which the patient is directly identifiable.

9. The system of claim 8 wherein the mechanism that generates the delegated token comprises a token editor by which one or more patient attributes in the patient token are able to be added, removed or modified.

10. The system of claim 8 wherein the anonymized token is transmitted to the insurer from a healthcare provider that provided a medical service to the patient.

11. The system of claim 8 wherein the anonymized token is transmitted to the insurer by a pharmacy that provided a medical product to the patient.

12. The system of claim 11 wherein the pharmacy receives anonymized tokens comprising an endorsed delegated token including an anonymous endorsement and an anonymous unendorsed token, and wherein the mechanism that generates the anonymized token from the received tokens comprises a mechanism that combines the endorsement associated with the patient and an unendorsed token from a healthcare provider.

13. The system of claim 8 further comprising means for uploading an encrypted patient record to a storage service.

14. The system of claim 13 wherein the anonymized token includes information by which a trusted party may decrypt the encrypted patient record.

15. The system of claim 8 further comprising means for uploading an anonymous version of a patient record to a data aggregator service.

16. One or more computer-readable media having computer-executable instructions, which when executed perform steps, comprising:
generating an anonymized token corresponding to a patient token associated with a patient and an insurer, the anonymized token identifying a healthcare provider and one or more medical services provided to the patient, without including information by which the patient is directly identifiable;
encrypting a patient record based upon the one or more medical services for uploading to a storage service; and
transmitting the anonymized token to a recipient for payment.

17. The one or more computer-readable media of claim 16 having further-executable instructions comprising, generating an anonymous endorsed token that contains information corresponding to a prescription, the anonymous endorsed token comprising an anonymous endorsement associated with a patient and an anonymous unendorsed token transmitted to a pharmacy recipient.

18. The one or more computer-readable media of claim 17 having further-executable instructions comprising, printing or otherwise outputting a representation of the endorsement.

19. The one or more computer-readable media of claim 17 having further-executable instructions comprising, combining data corresponding to the unendorsed token with data corresponding to the endorsement into an anonymous combined token, and transmitting the anonymous combined token to a recipient for payment.

20. The one or more computer-readable media of claim 16 having further-executable instructions comprising, decrypting the patient record as part of an audit.
